(19) United States
(12) Patent Application Publication
(10) Pub. No.: US 2023/0081318 A1
(43) Pub. Date: Mar. 16, 2023

(54) SMART DEVICE ACCESS SYSTEM

(71) Applicant: Inter IKEA Systems B.V., LN Delft (NL)

(72) Inventors: Per SIGURDSSON, Bunkeflostrand (SE); Mattias SCHILL, Älmhult (SE); Jeremy Edward VINY, Malmö (SE)

(21) Appl. No.: 17/476,272

(22) Filed: Sep. 15, 2021

(51) Int. Cl. H04L 29/06

(52) U.S. Cl. CPC H04L 63/105

(57) ABSTRACT

Methods and systems for managing access to smart devices. One aspect is a method for providing access to at least one smart device, the method comprising identifying the at least one smart device that is in data communication with a smart device hub, storing user level access permissions including a global user level, communicating with a user device, the user device being associated with a stored user level access permission, the global user level allowing the user device to remotely connect to the smart device hub, determining the user level access permission for the user device, determining whether the user device has permission to access the at least one smart device based on the user level access permission, wherein to access the at least one smart device requires the global user level, and providing access to the at least one smart device to the user device.

### BACKGROUND

Typically, a smart device system includes many devices. Examples of smart devices include smart light bulbs, smart locks, and smart speakers. The smart devices are positioned in different locations in a home. For example, smart devices can be placed in different rooms inside a house, a garage, and at different outside locations.

One or more applications are used to control and manage these smart devices. Sometimes a smart device uses a smart device system application to control and manage a group of smart devices. For example, a smart device system application can operate to configure one or more of the smart devices, implement timers, implement automations, add devices, and remove devices.

In current smart device systems, users have the same access permissions to all smart devices in the system. In some examples, the smart device system may have one administrator with more access than other users.

### SUMMARY

In general terms, this disclosure is directed to methods and systems for managing access to smart devices. In some embodiments, and by non-limiting example, this disclosure is directed to a smart device hub which manages access to one or more smart devices.

One aspect is a system comprising at least one personal smart device and a smart device hub including a processor, and a memory storage device, the memory storage device storing instructions that, when executed by the processor, cause the smart device hub to identify the at least one personal smart device that is in data communication with the smart device hub, store user level access permissions including a global user level, communicate with a user device, the user device being associated with a stored user level permission, wherein the global user level allows the user device to remotely connect to the smart device hub, determine the user level access permission for the user device, determine whether the user device has permission to access the at least one personal smart device based on the user level access permission, wherein to access the at least one personal smart device requires the global user level, and provide access to the at least one personal smart device to the user device.

Another aspect is A user device, the user device comprising an associated user access level permission, a processor, and a memory storage device, the memory storage device storing instructions that, when executed by the processor, cause the user device to generate a user interface to selectively provide access to at least one personal smart device via a smart device hub, communicate with the smart device hub to access the at least one personal smart device, and receive and display the at least one personal smart device determined to be accessible, wherein to access the at least one personal smart device requires a global user level assigned as the associated user access level permission and the global user level allows the user device to remotely connect to the smart device hub.

A further aspect is a method for providing access to at least one smart device, the method comprising identifying the at least one smart device that is in data communication with a smart device hub, storing user level access permissions including a global user level, communicating with a user device, the user device being associated with a stored user level access permission, the global user level allowing the user device to remotely connect to the smart device hub, determining the user level access permission for the user device, determining whether the user device has permission to access the at least one smart device based on the user level access permission, wherein to access the at least one smart device requires the global user level, and providing access to the at least one smart device to the user device.

### BRIEF DESCRIPTION OF THE DRAWINGS

FIG. 1 illustrates an example smart device system.

FIG. 2 illustrates an example smart device hub.

FIG. 3 illustrates an example smart device.

FIG. 4 illustrates an example method for managing access to one or more smart devices.

FIG. 5 illustrates an example method for assigning user level access.

FIG. 6 illustrates an example method for claiming a smart device.

FIG. 7 illustrates example user interfaces for claiming a smart device.

FIG. 8 illustrates an example flow diagram for claiming a smart device.

FIG. 9 illustrates an example method for determining accessible devices for a user.

FIG. 10 illustrates an example user access level framework.

FIG. 11 illustrates an example device access level framework.

FIG. 12 illustrates an example architecture of a computing device.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In general terms, this disclosure is directed to methods and systems for managing access to smart devices. In some embodiments, and by non-limiting example, this disclosure is directed to a smart device hub which manages access to one or more smart devices. Although in many of the examples described herein include a single smart device hub, other embodiments include several smart device hubs operating together. Additionally, in some examples, the smart device hub operates together with applications on one or more remote servers.

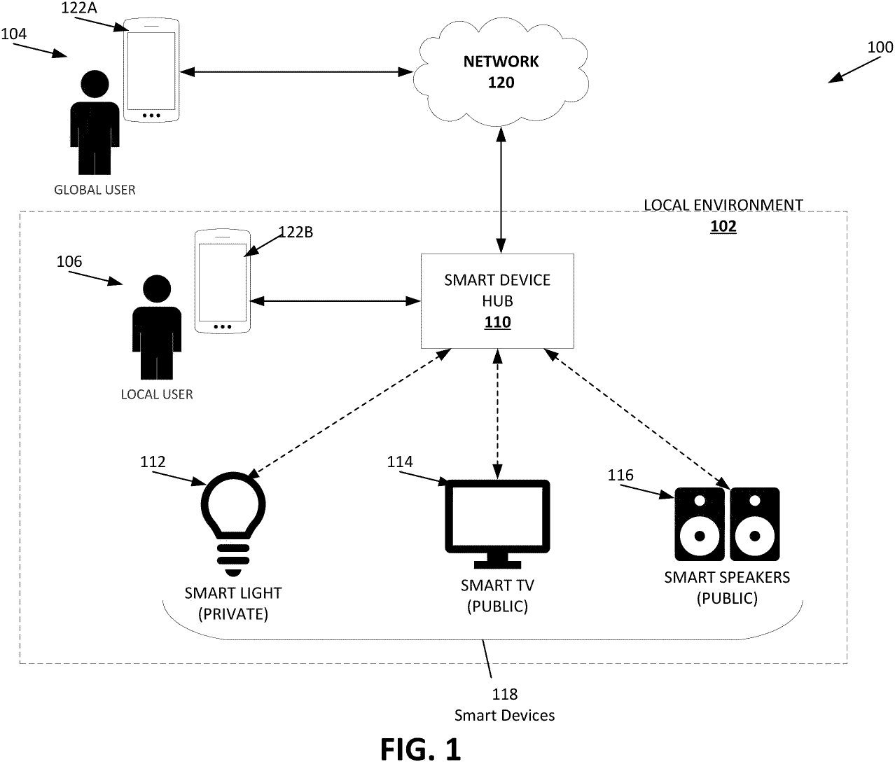

FIG. 1 illustrates an example smart device system 100. The smart device system 100 includes a local environment 102. Outside of the local environment 102, the smart device system 100 includes a global user 104 with a user device 122A connected to the smart device hub 110 via the network 120. The user device 122A may be connected to the Smart device Hub 110 via a remote server, where the remote server may provide functionality such as user authentication. The local environment 102 includes a local user 106 with a user device 122B, a smart device hub 110, and smart devices 118. The smart devices 118 include a smart light 112, a smart tv 114, and smart speakers 116.

The local environment 102 defines an area where a user attempting to access the smart devices 118 is local to the smart device hub 110. In some examples, the local environment 102 is defined by the range of a local Wi-Fi® network to which the smart device hub 110 is connected. Other local or personal area network technologies can also be used in other embodiments. For example, the local network may be a Bluetooth® Low Energy (BLE) network. In some examples, the local environment may be a set distance from the smart device. For example, a device associated with a user may send current location information (for example, using GPS data) to the smart device hub 110, and the smart device hub 110 determines whether the user is local or remote based on the current location information.

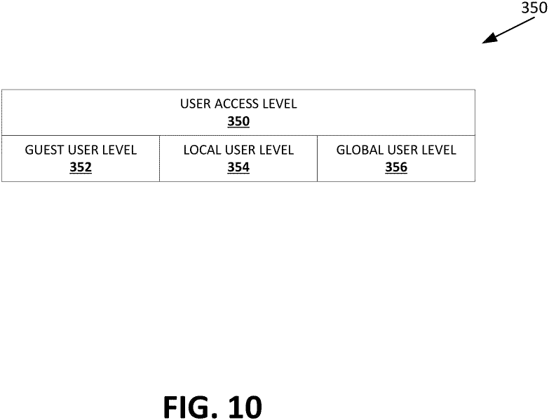

In some embodiments, a user is assigned a user access level which defines the level of access to one or more of the smart devices 118. Examples of the user access level include a global user level and a local user level. Another possible user access level is a guest user level. Further examples, of user access levels and associated permissions for the different levels are described herein. In particular, details related to user access levels are described in FIG. 10.

The global user 104 has a user access level assigned the global user level. In the example shown, the global user 104 is able access the smart device hub 110 via a remote connection. For example, the global user’s user device 122A connects to the network 120 using a telecommunication network or another Internet access point. In some embodiments, the global user is able to access one or more of the smart devices 118 whenever the user has network connectivity. For example, the global user 104 can access the smart devices when the user is locally or remotely connected to the smart device hub 110. In some embodiments the global user 104 receives a link or an address which allows the global user to connect and access the smart device hub 110. In some embodiments, in addition to a link to the smart device hub 110 the global user 104 includes the right preferences and authentication configurations to access the smart device hub 110.

The local user 106 has a user access level assigned the local user level. In the example shown, the local user 106 is locally connected to the smart device hub 110. In some embodiments, the local user 106 is only able to access one or more of the smart devices 118 when it is determined that the local user is locally connected to the smart device hub 110. In some embodiments, the local user 106 does not have an account. In some embodiments, the local user 106 does not have a link which allows the local user 106 to access the smart device hub 110 outside the local environment 102. In some examples, the local user 106 access to less smart devices 118 than the global user 104.

In some examples, the global user 104 has access to more smart devices 118 than the local user 108. In one example, only a global user 104 can claim one of the smart devices 118 as a personal device. In some embodiments, the local user may only have access to smart devices with a device access level assigned as the public device level.

The smart device hub 110 manages the smart devices 118, including providing a user access to one or more of the smart devices 118. The smart device hub 110 connects to the smart devices 118 and user devices including user devices 122A and 122B associated with the global user 104 and the local user 106. In some embodiments, the smart device hub 110 receives a command from a user to control one or more of the smart devices 118. The smart device hub 110 forwards the command to the one or more smart devices 118 which perform an action based on the command. Additionally, the smart device hub 110 manages what users have access at to the smart devices 118 at different locations and determines which of the smart devices 118 are accessible to each user.

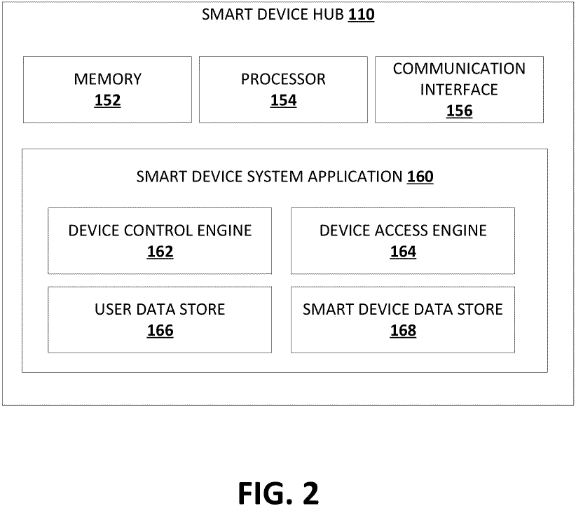

In some embodiments, the smart device hub 110 uses a personal area network to connect directly or indirectly with the smart devices 118. Examples, of personal area network protocols include Zigbee® and Matter/Thread. The smart device hub 110 also communicates with one or more user devices associated with one or more users. In the example, shown the smart device hub 110 is connected locally to the user device 122B which is associated with the local user 106 and remotely via the network 120 to the user device 122A associated with the global user 104. In some examples, connecting locally to a device is based on connecting to the user device over a local network. An example of a local network includes a local Wi-Fi network. Other protocols can also be used to connect to a device locally. In the example shown, the smart device hub 110 is connected to the user device 122A associated with the global user remotely (for example, via the network 120). Typically, the user devices include a smart device system application to interact with the smart device system 100. An example of the smart device hub 110 is illustrated in FIG. 2.

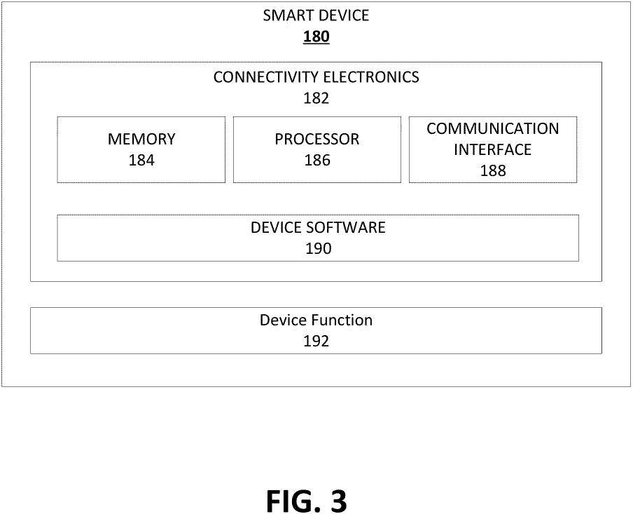

The smart devices 118 typically include a function and digital connectivity. In some examples, one or more of the smart devices communicate with a computing device to control a function of the smart device. For example, a user may control a smart device by sending a command to turn on/off the smart device. In some examples, the smart device includes a sensor and the smart device monitors and sends the data collected by the sensor to a user. An example of a smart device is illustrated in FIG. 3.

Examples of smart devices 118 include a smart light 112, a smart tv 114, and smart speakers 116. In some embodiments, a smart device system application on a user device allows the user to control some or all of the smart devices 118. For example, the user may be able to turn on/off the smart light 112, make a video content selection on the smart tv 114, and adjust the volume on the smart speakers 116.

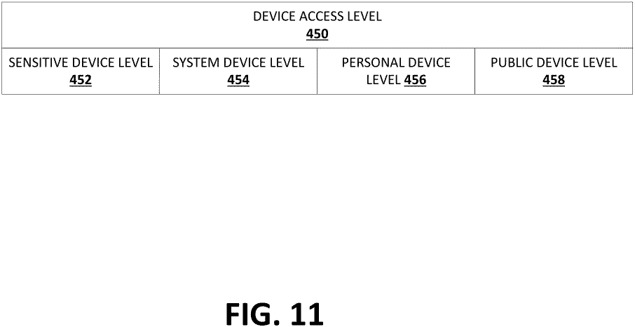

In some examples, the smart devices 118 are assigned device access levels. Examples of device access levels include public device level, personal device level, system device level, and sensitive device level. Further examples, of device access levels and associated permissions for the different levels are described herein. In particular, details for different device access levels are described in FIG. 11.

In the example shown, the smart light 112 has a device access level assigned as the personal device level. In some embodiments, a smart device is claimed by a user. The claimed device’s device access level is then assigned the personal device level and associated with the user who claimed the device. The user claiming the device is set as the device owner. In some examples, only the user who claimed the smart device is able to control the smart device. In some examples, multiple users may claim a smart device as a group or a user set as the device owner can share access to the device. In some examples, only a global user can access device assigned the personal device level.

The smart tv 114, and the smart speakers 116 are assigned the public device level. In some embodiments, smart devices assigned the public device level are accessible to all users which are allowed access to the smart device hub 110.

The smart device system 100 includes a network 120. The network 120 connects the user device 122, associated with the global user 104, to the smart device hub 110. In some examples, the network 120 is a public network such as the Internet. In example embodiments, the network 120 connects with the smart device hub 110 through a Wi-Fi® network and the global user 104 through a Wi-Fi® or cellular network.

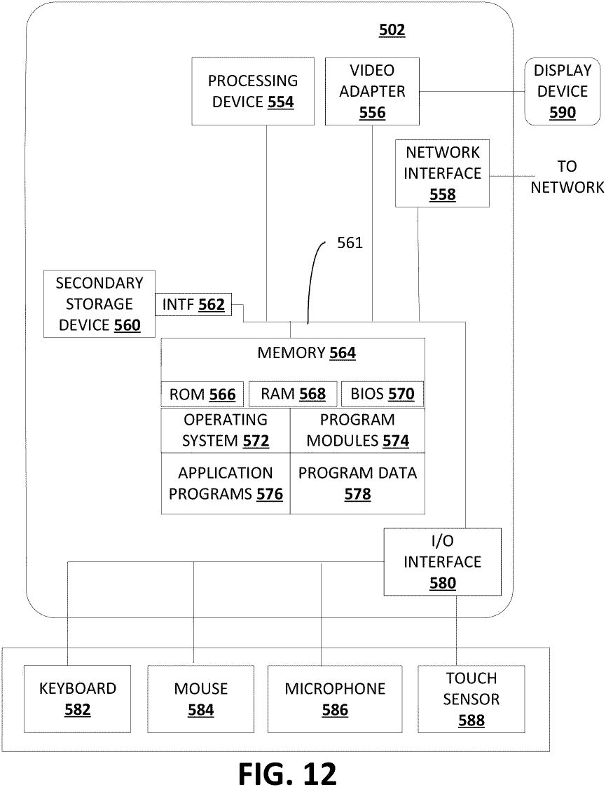

The user devices 122A and 122B are computing devices with network connectivity. Examples of user devices include, computers, laptops, tablets, smart phones, smart watches, smart speaker, digital voice assistant etc. An example architecture of a computing device is described in more detail in FIG. 12.

FIG. 2 illustrates an example smart device hub 110. The smart device hub 110 includes a memory 152, a processor, 154, a communication interface 156, and a smart device management application 160. The smart device management application 160 includes a device control engine 162, a device access engine 164, a user data store 166, and a smart device data store 168.

The memory 152 operates to store data and instructions. In some embodiments, the memory 152 stores instructions for the smart device management application 160.

The processor 154 operates to execute the instructions. In some embodiments the instructions when executed by the processor 154 cause the smart device hub to perform the smart device management application 160. The communication interface 156 is configured to interface with one or more different networks to connect with various smart devices and user device. Examples of the memory 152, processor 154, and communication interface 156 are described in more detail in reference to FIG. 12.

The smart device management application 160 manages the smart devices, and user information. In some embodiments the smart device management application 160 includes a device control engine 162, a device access engine 164, a user data store 166, and a smart device data store 168.

The device control engine 162 operates to communicate and control one or more smart devices. For example, the device control engine may include information about a smart device, including possible controls. The device control engine 162 provides available controls and other smart device information to a user device. When a command is sent to the smart device hub 110 from a user device, with valid permission, the device control engine forwards the command to the smart device so the smart device can preform a function based on a command. The device control engine 162 can provide other smart device system services. For example, the device control engine 162 can manage, set up, and control smart device system automations, timers, and add or remove devices.

The device access engine 164 manages permissions for a smart device system. In some embodiments, the device access engine 164 manages user access to the smart devices. In other embodiments, the device access engine 164 manages what devices are available to different users. In further embodiments, the device access engine 164 manages what users have access to the smart devices and what devices are available to different users.

In some examples, the device access engine 164 determines permission for various users to access the smart devices based on associated user access levels. In some examples, the user permissions levels include a local user level, a global user level, and a guest user level. Further description of the permissions for these user levels are described herein. The user access levels for the users are stored in the user data store 166.

In some examples, the user permissions for a user device are stored in the smart device hub 110. In some embodiments, only a user device with a global user level includes a link, application configurations, and authentication configuration to access the smart hub remotely.

In some examples, the device access engine 164 uses a device access level to determine permissions for different smart devices. Examples of device access levels include sensitive device level, system device level, personal device level, and public device level. The device access levels for various smart devices are stored in the smart device data store 168.

The user data store 166 stores information for various users of a smart device system. In some examples, a user creates an account which may include information such as personal information, list of devices associated with the user, and user access level permissions. In some examples, some or all of the users are required to create an account. In some embodiments, a global user is required to create an account. In some examples, a user identifier is associated with a connected user device and an account is not required. In these examples, the user identifier is stored with an associated user access level in the user data store 166.

The smart device data store 168 stores information for the smart devices in the smart device system. Examples of information stored include: a smart device identifier, a smart device name, data collected from the smart device, assigned location for the smart device, automations for the smart device, configurations of the smart device, current settings of the smart device etc. Additionally, in some embodiments, the smart device data store 168 stores a device access level permission for a smart device. In some examples, a device access level permission includes a private access level. In these examples, the smart device data store 168 stores one or more users which are set as owners for the personal device. In some examples, a device access level permission includes a sensitive device access level. In these examples, the smart device data store 168 may store a passcode which is required to access the sensitive device.

FIG. 3. illustrates an example smart device 180. The smart device 180 includes connectivity electronics 182 and a device function 192. The connectivity electronics 182 include a memory 184, a processor 186, a communication interface 188, and device software 190.

The connectivity electronics 182 is configured to connect to and communicate through the communication interface 188 with other smart devices, the smart device hub, and user devices via the smart device hub. The connectivity electronics are further used to control the smart device using the device software 190.

In some embodiments, the memory 184 operates to store instructions which when executed by the processor 186 cause the smart device 180 to execute the device software 190. Further examples of the memory 152, processor 154, and communication interface 156 are described in reference to FIG. 12.

The device software 190 operates to control the device function and provide access and information to other devices in the smart device system. In some examples, the device software 190 performs automations and timers to control the device function. For example, the device software 190 may include a timer to turn on a light at a certain time. In some examples, the device software 190 receives commands from the smart device hub 110 instructing the smart device 180 to perform the command. For example, the device software 190 may receive a command to turn on a smart TV. In some examples, the device software 190 is includes a smart assistant which receives voice commands and sends the voice commands to connected smart devices. Many other examples for device software 190 are possible. For example, timers, automation, and commands are stored and transmitted from the smart device hub to the smart devices and the smart device stores only the firm to change the settings of the device and basic functionality.

The smart device 180 includes a device function 192. The device function includes the hardware and software used to operate the smart device 180. For example, the device function 192 for a smart lock includes the hardware, such as the deadbolt, and electric motor to move the deadbolt. In other examples the device function may include sensing equipment. For example, a smart thermometer includes a sensor to detect temperature or a microphone to record audio. Many other examples of device function 192 for a smart device 180 are possible.

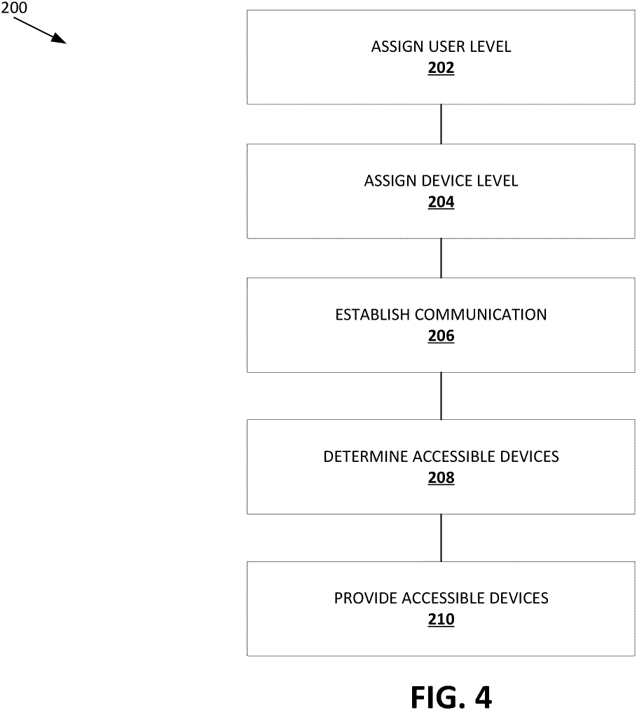

FIG. 4 illustrates an example method 200 for managing access to one or more smart devices. The method 200 includes the operations 202, 204, 206,.208, and 210. In some examples, the method 200 is executed on the smart device hub 110, illustrated in FIGS. 1 and 2.

The operation 202 assigns a user access level. In some examples, the user access level assigned to the first user to connect with the smart device hub is automatically set as the global user access level if the necessary information is provided by the user. In some embodiments, a user with the global user access level can invite other users. These users are assigned the user access level given by the inviting user. For example, a user with the global user access level can invite another user and assign the new user the global user access level, local user access level, or guest user access level. In some examples, a local user can also invite other users and assign user access levels. The assigned user access levels are stored in the smart device hub.

The operation 204 assigns a device access level. Typically, when a device is added the device is assigned the public access level. In these examples a user with access to the smart device can claim the device as a personal device and the device access level is updated to the personal device level. In some examples, specific devices may have a predefined access level. For example, a smart lock may have a predefined device access level assigned the sensitive device level. The assigned device access levels are stored in the smart device hub.

The operation 206 establishes communication with a user device. In some examples, the smart device hub receives a message from a user device when the associated user opens the smart device system application. In other examples, the user needs to request to access the smart device hub. In some examples, a user assigned the local user level is unable to communicate with the smart device hub when the user device is remote to the smart device hub. For example, the user device may not have a link or address of the smart device hub and, accordingly, has no way to access the smart device hub unless the user device is local to the smart device hub.

The operation 208 determines accessible devices. In some embodiments, accessible devices are determined based on one of or both the user access level for the requesting user and the device access levels for each of the connected devices. In some embodiments, the smart device hub checks the user access level for the requesting user. If the user has a valid user access level for the request the method 200 continues to the operation 210. In some examples, the smart device hub checks for devices that are currently able to connect with the smart device hub. Next, smart device hub will check the device access level for each of the connected devices and determine which of these devices the user has permission to access.

The operation 210 provides accessible devices to the user device. In some embodiments, the smart device hub sends a list of accessible smart devices and the status of the smart devices. In some examples, the smart hub will only provide the smart devices that are accessible to the user keeping the other smart devices hidden. In other examples, all the smart devices are provided to a user, but the user only able to control the smart devices that are accessible to that user. In some examples, access to the smart devices is further based on the user access level. For example, a local user may only be able to access smart devices with a device access level assigned the public device level.

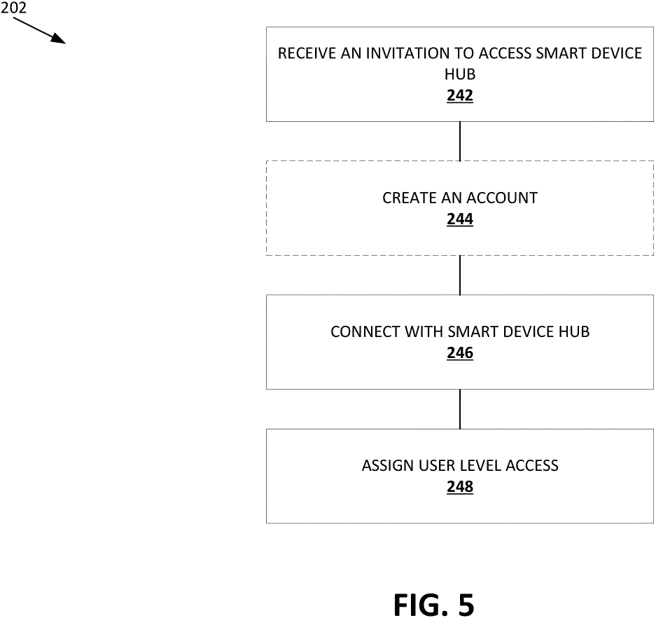

FIG. 5 illustrates an example method 202 for assigning user level access for a user. The method 202 includes the operation 242, 244, 246, and 248. In some examples, the method 202 another example of the operation 202, illustrated in FIG. 4, performed from the user device perspective.

The operation 242 receives an invitation to access the smart device hub. In some examples, the invitation is received over an electronic message. In other examples, the invitation is encoded in a machine-readable code (e.g., a QR code) and scanned by the user device.

In some examples, the operation 244 creates a user account. In some embodiments, a user is required to create an account to access the smart device system. In other examples, in order to receive the global user level, the user must create an account and users with the local user level or guest user level are not required to create an account. In alternative embodiments, no users are required to create a user account.

The operation 246 connects with the smart device hub. In some examples, when a user opens or loads the smart device system application the application performs instructions causing the user device to connect with the smart device hub. In other examples, the user provides inputs to the user device to request access to the smart device system.

The operation 248 assigns a user access level. In some examples, the user access level is assigned as described herein. In other examples, a user is assigned a default user access level (such as the local user access level) and another user with the proper permissions can update. In some examples, the first user to connect to the smart device hub is automatically assigned the global user access level. In some examples, a user that setup or login to an account in the smart device system application installed on the user device is assigned the global user access level. In some examples, a user that does not setup or login to an account in the smart device system application installed on the user device is assigned the local user access level. In some examples, a user that is assigned the local user access level can change to be assigned the global user access level by setup or login to an account in the smart device system application installed on the user device.

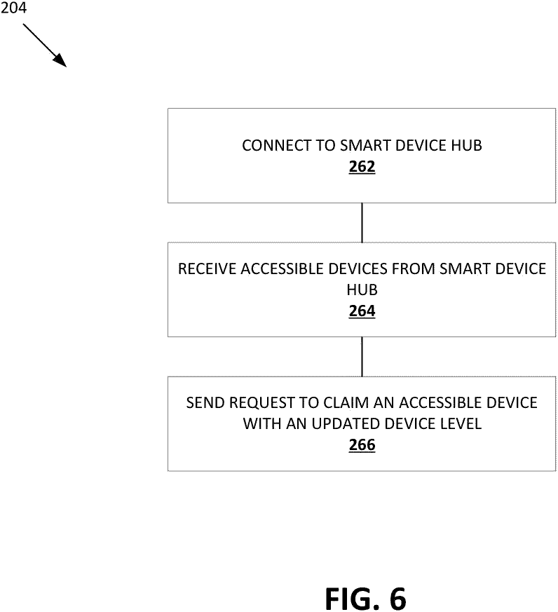

FIG. 6 illustrates an example method 204 for claiming a smart device. The example method 204 includes the operations 262, 264, and 266. In some examples, the method 204 is an example of the operation 204, illustrated in FIG. 4, from the perspective of a user device.

The operation 262 connects to a smart device hub. After the user device communicates a request to access the smart devices, the smart device hub provides accessible devices to the user device at the operation 264.

The operation 266 sends a request to claim an accessible device with an updated device level. In some examples, a user may select one or more of the accessible devices as a personal device. For example, a user may wish to select a smart light bulb in their room as a personal device. The user claims a device as a personal device which will update the device access level to the personal device level and set the user as an owner of the device.

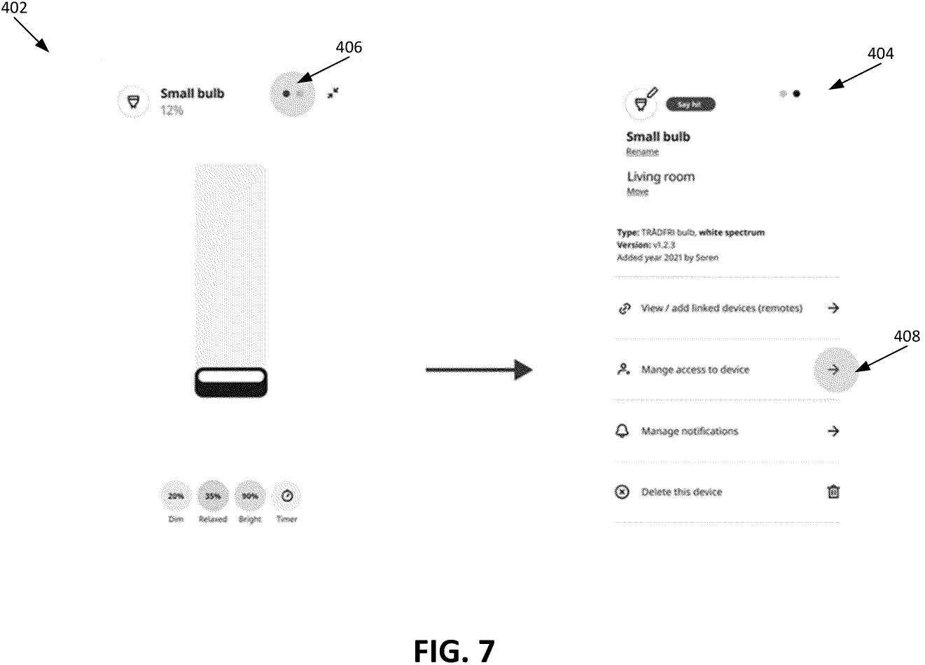

FIG. 7 illustrates example user interfaces 402 and 404 for claiming a smart device. The user interface 402 displays a user interface for controlling a light bulb. The user interface 402 includes a switch with a dimmer as well as a battery life indicator for the light bulb. In this example, the user can select a settings button 406 which will update the user interface 402 to the user interface 404. The user interface 404 includes further details on the smart device. A user can select the manage access to device button 408 which will provide options to update the device access level for the smart device. In some examples, updating the device access level includes claiming the smart device as a personal device. In some embodiments, the user interface 404 is only accessible or selectable by a user with a global user access level.

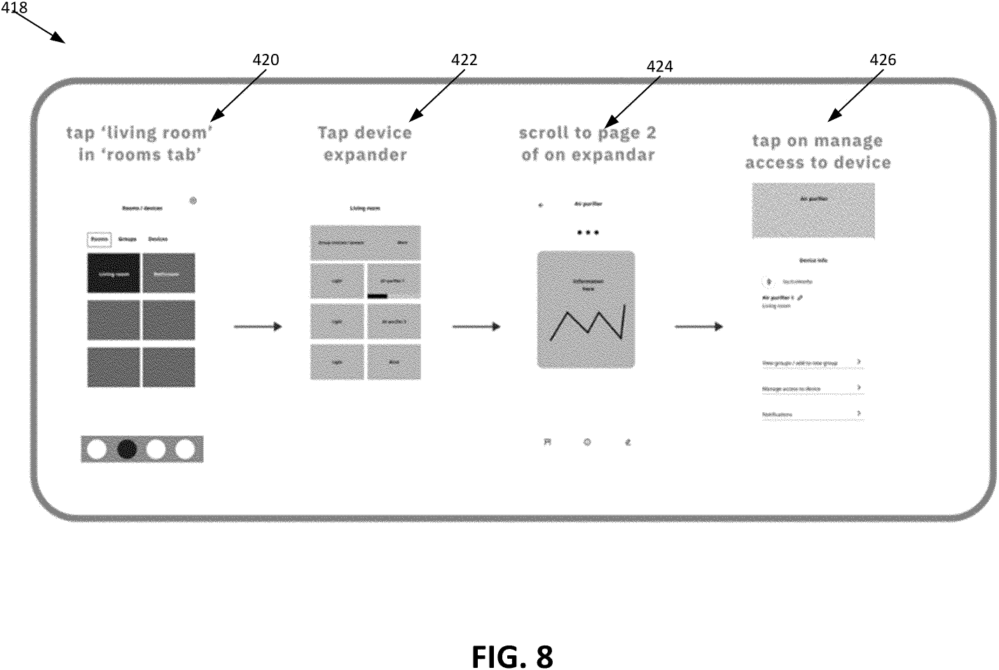

FIG. 8 illustrates an example flow diagram 418 for claiming a smart device. The flow diagram includes user interfaces 420, 422, 424, and 426. The user interface 420 displays a rooms tab. The rooms tab shows different rooms in the smart device system. In this example, the user selects the living room selection to advance to the user interface 422. The user interface 422 displays the smart devices in the living room. The user can select a smart device to see more information about the smart device at the user interface 424. The user scrolls the user interface 424 to show the user interface 426. At the user interface 426 a user can select manage smart devices to update the device access level for the selected device. In some examples, the user interface 426 is only accessible or selectable by a user with a global user access level.

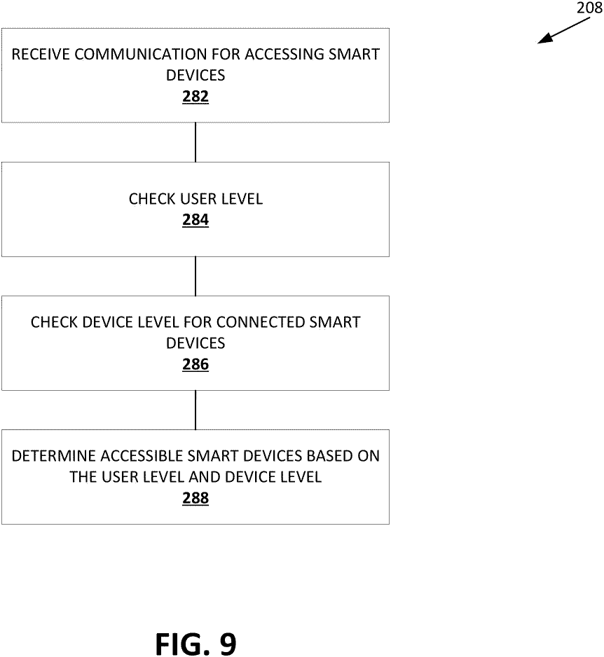

FIG. 9 illustrates an example method 208 for determining accessible devices for a user. The method 208 includes the operation 282, 284, 286, and 288. In some embodiments, the method 208 is performed on the smart device hub 110. The method 208 is another example of the operation 208 illustrated in FIG. 4.

The operation 282 receives a communication for accessing one or more smart devices. Examples for the operation 282 are described herein.

The operation 284 checks a user access level. In some examples, the operation 284 determines what user is attempting to access the smart devices. In some examples, this is based on the user account logged in on the requesting user device. In other examples, this is done by a user identifier of the device (device ID) requesting access (e.g., mac address). Next, the operation 284 checks the user access level for the user.

The operation 286 checks the device access level for each of the connected smart devices. First, the smart device hub checks for the current set of connected smart devices. Next, the smart device hub retrieves the device access levels for each of the connected smart devices.

The operation 288 determines accessible smart devices based on the user access level and the device access level and optionally the device ID. The operation 288 checks whether the user has the correct user access level to connect to the smart device system. In some examples, this is based on whether the user has a global or local user access level. In some examples, local users only have access smart devices assigned the public device level. Next the operation 288 checks which smart devices are accessible to the user based on the device access levels. For example, the user only has access to smart devices with the personal device level that the user is set as an owner. Additionally, depending on the assigned user access level the user may not have access to devices assigned the system device level or the sensitive device level.

FIG. 10 an example user access level framework. The framework includes a user access level 350. Example permission levels for the user access level 350 include the guest user level 352, the local user level 354, and the global user level 356.

The user access level 350 is an access level assigned to a user. The user access level defines what level of control the user has to the smart device system and where the user can access the smart device system.

One possible user access level 350 includes the guest user level 352. Typically, the guest user level 352 includes limited access to the smart devices. In different configurations limited access can include access for a limited time, limited access to control one or more of the smart devices, or prohibit access to some devices. In typical embodiments, the guest user level only allows local control of the smart devices. In some embodiments, the guest user must have access to the same local network as the smart device hub to access the smart devices. In some examples, the guest user level 352 limits the guest user to control functionality of public devices in the system. In these examples the guest user does not have options to configure the system. In some examples, the configuration options are hidden in such a way that the guest user is not aware of these options. In other examples, the configuration options are visible but disabled for users with the guest user level 352.

The guest user may need to receive an invitation to access the smart device system. In some examples, the invitation is sent electronically to the guest user’s device. In other examples, the invitation is encoded in a machine-readable code, such as a QR code, which the guest user scans to access the smart device system. In some embodiments, a user needs to create an account to access the smart device system. In these embodiments, the smart device hub may assign the user access level to the user account. In other embodiments, a guest user does not need to create an account. The smart device hub uses a user identifier which is assigned the guest user level 352. The user identifier can be a user account or a device ID. For example, a mac address from the user’s device can be used to track a device associated with a guest user.

One non-limiting scenario to illustrate the use of the guest user level 352 includes where a visitor is at the smart device system owner’s house. The visitor may be interested in using the smart device system. However, the system owner may want to limit the options available to the visiting member. For example, the owner may want to limit the visitor from changing room setups, names of devices, automations, and options to add or delete devices, while still allowing the visitor to control the functionality of at least some of the smart devices. In this example, the owner could invite the visitor to the smart device system with the guest user level 352.

Another possible user access level 350 is the local user level 354. In some embodiments, a user assigned the local user level 354 is only able to access the smart devices when the user’s device is connected to the same local network as the smart device hub. Other methods for determining whether the user’s device is local to the smart device hub can also be used. In some examples, the local user receives an invitation via an electronic message. In other examples, the local user scans a machine-readable code to receive an invitation. In some examples, the local user can invite additional users.

In some embodiments, a user assigned the local user level 354 controls the smart devices and manage the smart devices (rename, group, remove, add). In some examples, the local user can create rename, update, and delete timers and automations. In some embodiments, a user assigned the local user level 354 can only access devices assigned the public device level.

Yet another possible user access level 350 includes the global user level 356. A user assigned the global user level 356 can access the smart device system locally or remotely. Generally, the global user level 356 has the highest level of permissions to control, manage devices, set up/manage timers, and set up/manage automations. In some examples, the global user is required to have a user account. In some embodiments, users assigned the global user level 356 can add or remove other users and assign users to any of the user levels. Users assigned the global user level 356, in some embodiments, are able to set other users as owners of smart devices with the personal device level.

In some embodiments only users with the global user level 356 can be set as an owner of a personal device. In other embodiments, users assigned the local user level 354 can receive ownership of a personal device by a user with the global user level 356, and thus get digital access to control and configure that device.

One non-limiting example of a user with the global user level 356 and a user with the local user level 354 is with a parent user as the global user access level and a child with the local user level 354. In this example, the parent may not want the child to have access to the smart devices when the child is remote. For example, a parent may not want a child to turn on and off a light while the child is at school. In this example the parent can assign the child the local user level 354, so the child is only able to control the smart devices when the child is local.

FIG. 11 illustrates an example device access level framework. The framework includes a device access level 450. Example permission levels for the device access level 450 include the sensitive device level 452, the system device level 454, the personal device level 456, and the public device level 458.

The sensitive device level 452 is assigned to devices which require additional privacy or are not allowed to become public device level 458 devices. An example smart device which, in some examples, is assigned the sensitive device level 452 is a smart lock. In some embodiments to access a sensitive device level 452 device requires a user to enter a secure passcode. In these examples, the secure pass code is required to add, name, update and delete the sensitive device level 452 device. In some examples, only users which are specifically specified as owners of the sensitive device level 452 device are able to access the smart device.

One non-limiting example of a smart device with the sensitive device level 452 is a smart alarm system that includes locks on the doors and security cameras. The lock is controllable by physical access to the lock, and can be opened by a code, a key fob, NFC etc. However, digital access to the lock is restricted by default. Users specified as owners of the smart alarm system can access the lock and camera by providing a pass code on their user devices. In some cases, the code is the same as the code for physically unlocking the lock (e.g., via a key pad). In these cases, there are different access levels for such codes as well, e.g., one type of code that only unlocks the lock but restricts digital access to the lock (typically given to children, and guests), and one type of code that both unlocks the lock and give digital access to the lock (typically given to adults of the home). In some embodiments, only users assigned the global user level can access smart devices assigned the sensitive device level.

The system device level 454 is typically assigned to devices which are normally controlled by the smart device system. For example, devices which are typically only controlled through automations with little to no manual control. For example, outdoor lights may include a timer such that the lights always turn on a dusk and off at dawn. Another non-limiting example includes a bathroom light which only turns on in response to motion detected on a sensor.

In many embodiments, the system devices are hidden by default. A user can find these devices by requesting access to the system device level 454 devices. For example, a user can select a user interface element to present all system device level 454 devices. In one example, a user must perform an extra activity such as filing in a checkbox to access the system device level 454 devices. In some embodiments, the system device level 454 devices are not accessible by a user assigned the guest user level but are accessible by users assigned the local user level or global user level. In further examples, only users assigned the global user level can access system devices.

The personal device level 456 devices are typically the public device level 458 smart devices which have been claimed by a user as a personal device. Typically, a user claiming a personal device is set as an owner of that device. In some examples, smart devices assigned the personal device level 456 are only visible or accessible by the owner of the personal device. In some examples, there can be multiple owners of a personal device. In some examples, a user can claim all smart devices in a room as personal devices. In some examples, a personal device owner can share the smart device permanently or for a set period of time. In some embodiments, in order to claim a device as a personal device a user is required to have an account or create an account.

Although in the typical embodiment public device level 458 devices are claimed and assigned the personal device level 456, in some examples some devices are required to start as personal devices and are assigned an owner when added. For example, a lock for a drawer can be configured to onboard as a personal device with an owner added when the lock is connected to the smart device system.

One non-limiting example for personal device level 456 devices includes where a teenager in a house has several devices in their room. Examples of smart devices in this teenager’s room include smart light bulbs, a smart speaker, and a smart lock on a drawer with a diary. The teenager may not want their parents or siblings to access these devices. In this example, the teenager can claim these devices as personal device level 456 devices. Once these devices are assigned the personal device level 456 the devices will no longer be accessible to the teenager’s family members. In addition to the extra privacy hiding these devices from the family members also reduces visual clutter in the smart device system application.

In another non-limiting example, a parent may claim all devices in a room as personal device level 456 devices. For example, the parent may claim a lock for a liquor cabinet as a personal device level 456 device. The parent may wish to share access to the personal device level device with another adult visitors Accordingly, in this example, the owner of a personal device can share ownership that specific private device, or the owner of all devices in a specific room in the house can share all devices in that room.

The public device level 458 is generally available to all users with access to the smart device system. In some embodiments, smart devices assigned the public device level 458 can be accessed by all user levels (e.g., local user level, global user level and, guest user levels) when locally connected to the user device, and by global users when remotely connected to the user device. Typically, new devices are assigned the public device level 458 when the device is added. In general, public devices can be see and used by all users (e.g., guest users, local users, and global users).

In some embodiments described herein both the user access levels and device access levels are used to configure a system. However, some embodiments may be implemented with only the user access levels or only the device access levels. Additionally, some embodiments include all the different levels described and other embodiments include any combination of the different levels. For example, one configuration may only include a local user access level and a global user access level. Another may only use personal device level and public device level. Still a further example, may use a global user access level and a local user access level for the user access levels and include personal device level and public device level for the device access levels.

FIG. 12 illustrates an exemplary architecture of a computing device 502 that can be used to implement aspects of the present disclosure, including any of the plurality of computing devices described herein. The computing device 502 illustrated in FIG. 12 can be used to execute the operating system, application programs, and software described herein.

Examples of computing devices suitable for the computing device 502 include a desktop computer, a laptop computer, a tablet computer, a mobile computing device (such as a smartphone, mobile digital device, or other mobile devices), a computing device coupled with a kiosk, or other devices configured to process digital instructions.

The system memory 564 includes read only memory 566 and random-access memory 568. A basic input/output system 570 containing the basic routines that act to transfer information within computing device 502, such as during start up, is typically stored in the read only memory 566.

The computing device 502 also includes a secondary storage device 560 in some embodiments, such as a hard disk drive, for storing digital data. The secondary storage device 560 is connected to the system bus 561 by a secondary storage interface 562. The secondary storage devices 560 and their associated computer readable media provide nonvolatile storage of computer readable instructions (including application programs and program modules), data structures, and other data for the computing device 502.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 560 or system memory 564, including an operating system 572, one or more application programs 576, other program modules 574 (such as the software described herein), and program data 578. The computing device 502 can utilize any suitable operating system.

In some embodiments, a user provides input to the computing device 503 through one or more input devices. Examples of input devices include a keyboard 582, mouse 584, microphone 586, and touch sensor 588 (such as a touchpad or touch sensitive display). Other embodiments include other input devices. The input devices are often connected to the processing device 554 through an input/output interface 580 that is coupled to the system bus 561. These input devices can be connected by any number of input/output interfaces, such as a parallel port, serial port, game port, or a universal serial bus. Wireless communication between input devices and the interface is possible as well, and includes infrared, BLUETOOTH® wireless technology, 802.1 la/b/g/n, cellular, or other radio frequency communication systems in some possible embodiments.

In this example embodiment, a display device 590, such as a monitor, liquid crystal display device, projector, or touch sensitive display device, is also connected to the system bus 561 via an interface, such as a video adapter 556. In addition to the display device 590, the computing device 502 can include various other peripheral devices (not shown), such as speakers or a printer.

When used in a local area networking environment or a wide area networking environment (such as the Internet), the computing device 502 is typically connected to the network through a network interface 558, such as an Ethernet interface. Other possible embodiments use other communication devices. For example, some embodiments of the computing device 502 include a modem for communicating across the network.

The computing device 502 typically includes at least some form of computer readable media. Computer readable media includes any available media that can be accessed by the computing device 502. By way of example, computer readable media includes computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 502.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system comprising:
at least one personal smart device; and
a smart device hub including a processor, and a memory storage device, the memory storage device storing instructions that, when executed by the processor, cause the smart device hub to:
identify the at least one personal smart device that is in data communication with the smart device hub;
store user level access permissions including a global user level;
communicate with a user device, the user device being associated with a stored user level permission, wherein the global user level allows the user device to remotely connect to the smart device hub;
determine the user level access permission for the user device;
determine whether the user device has permission to access the at least one personal smart device based on the user level access permission, wherein to access the at least one personal smart device requires the global user level; and
provide access to the at least one personal smart device to the user device.

2. The system of claim 1, the system further comprising:
at least one public smart device;
wherein the user level access permissions include a local user level, the local user level only allows an associated user device to locally connect to the smart device hub and to access the at least one public smart device.

3. The system of claim 2, wherein the user level access permissions include a guest user level, the guest user level only allows an associated guest user device to locally connect to the smart device hub with limited access to control the at least one public smart device.

4. The system of claim 2, wherein the instructions when executed by the processor further cause the smart device hub to:
store device level permissions for each of the at least one public smart device and the at least one personal smart device;
wherein the device level permissions include a personal device level and each of the at least one personal smart device is assigned the personal device level, the personal device level being associated with a user identifier set as an owner; and
wherein access to the at least one personal smart device is further based on the user identifier being set as the owner.

5. The system of claim 4, wherein the user identifier is at least one of a user account and a device ID.

6. The system of claim 4, wherein the device level permissions further include a public device level and each of the at least one public smart device is assigned the public device level; and
wherein access to a smart device assigned the public device level is not based on the user identifier.

7. The system of claim 4, wherein the device level permissions further include a sensitive device level, wherein a smart device assigned the sensitive device level is accessible to a user device which provides a valid passcode.

8. The system of claim 2, wherein a user device having the local user level is able to locally connect to the smart device hub when the user device having the local user level and the smart device hub are both connected to the same private network.

9. The system of claim 1 wherein the instructions when executed by the processor further cause the smart device hub to:
store device level permissions for each of at least one system smart device;
wherein the device level permissions include a system device level, wherein at least one system smart device is assigned the system device level and is only accessible to a user device making a system device request.

10. The system of claim 1, wherein at least some of the at least one personal smart device include a physical control.

11. The system of claim 1, wherein a user account registered as an owner of the smart device hub is automatically assigned the global user level.

12. The system of claim 1, wherein the smart device hub connects with the at least one personal smart device using a personal area network protocol.

13. A user device, the user device comprising:
an associated user access level permission;
a processor; and
a memory storage device, the memory storage device storing instructions that, when executed by the processor, cause the user device to:
generate a user interface to selectively provide access to at least one personal smart device via a smart device hub;
communicate with the smart device hub to access the at least one personal smart device; and
receive and display the at least one personal smart device determined to be accessible, wherein to access the at least one personal smart device requires a global user level assigned as the associated user access level permission and the global user level allows the user device to remotely connect to the smart device hub.

14. The user device of claim 13, wherein the smart device hub stores a user access level for the at least one personal smart device and a user identifier associated with the user device, the user access level for the at least one personal smart device being a personal device level.

15. The user device of claim 13, wherein the associated user access level permission is a local user level which provides access to at least one public smart device when it is determined that the user device is locally connected to the smart device hub.

16. The user device of claim 15, wherein the user device is assigned the local user level by scanning a machine-readable code.

17. The user device of claim 13, wherein the associated user access level permission is assigned to a user account.

18. The user device of claim 13, wherein the associated user access level permission is a guest user level which provides limited access to control at least one public smart device when it is determined that the user device is locally connected to the smart device hub.

19. The user device of claim 18, wherein the user device is assigned the guest user level by scanning a machine-readable code.

20. A method for providing access to at least one smart device, the method comprising:
identifying the at least one smart device that is in data communication with a smart device hub;
storing user level access permissions including a global user level;
communicating with a user device, the user device being associated with a stored user level access permission, the global user level allowing the user device to remotely connect to the smart device hub;
determining the user level access permission for the user device;
determining whether the user device has permission to access the at least one smart device based on the user level access permission, wherein to access the at least one smart device requires the global user level; and
providing access to the at least one smart device to the user device.
